(19) United States
(12) Patent Application Publication
(10) Pub. No.: US 2006/0105235 A1
(43) Pub. Date: May 18, 2006

(54) Electrochemical energy source integrally formed in a non-conductive casing and method of manufacturing such an electrochemical energy source

(76) Inventors: Petrus Henricus Laurentius Notten, Eindhoven (NL); Martinus Jacobs Johannes Hack, Eindhoven (NL); Willem Jan Mulder, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 10/540,674

(22) PCT Filed: Dec. 10, 2003
(86) PCT No.: PCT/IB03/05962

§ 371 Date: Jun. 24, 2005

(30) Foreign Application Priority Data
Dec. 30, 2002 (EP) 02080581.8

(51) Int. Cl. H01M 2/02; H01M 10/04

(52) U.S. Cl. 429/176; 429/153; 29/623.1

(57) ABSTRACT

The invention relates to an electrochemical energy source integrally formed in a non-conductive casing, comprising: a first current collector embedded in said casing and further coupled to an anode, a second current collector embedded in said casing and coupled to a cathode, and an electrolyte and a separator between said anode and said cathode, wherein the casing comprises a portion of a housing of an electronic device. The invention further relates to a method of manufacturing an electrochemical energy source integrally formed in a non-conductive casing, wherein the casing comprises a portion of a housing of an electronic device, comprising the steps of: A) applying at least one electrochemical cell to said casing, which electrochemical cell comprises an anode, and a cathode, B) realizing a suitable configuration for said electrochemical cell, C) applying an electrolyte to said casing, and D) adapting the orientation of said casing such that said formed electrochemical energy source is at least substantially surrounded by said casing.

The invention relates to an electrochemical energy source integrally formed in a non-conductive casing, comprising: a first current collector embedded in said casing and further coupled to an anode, a second current collector embedded in said casing and coupled to a cathode, and an electrolyte and a separator between said anode and said cathode, wherein the casing comprises a portion of a housing of an electronic device. The invention further relates to a method of manufacturing an electrochemical energy source integrally formed in a non-conductive casing, wherein the casing comprises a portion of a housing of an electronic device, comprising the steps of: A) applying at least one electrochemical cell to said casing, which electrochemical cell comprises an anode and a cathode, B) realizing a suitable configuration for said electrochemical cell, C) applying an electrolyte to said casing, and D) adapting the orientation of said casing such that said formed electrochemical energy source is at least substantially surrounded by said casing.

An electrochemical energy source, such as a battery, which is integrated in a part of a housing of an electrical appliance is disclosed in the American patent publication U.S. Pat. No. 5,180,645. Providing an integrated battery (permanently) incorporated into or forming part of an appliance housing has numerous advantages. An integrated battery results commonly in a smaller overall size, lighter overall weight, and lower fabrication cost of the electronic device. However, these advantages of the known electrochemical energy source which is integrally formed with a part of a housing of an electronic device are counterbalanced by several drawbacks. One of the drawbacks is the relatively restrictive degree of freedom of design because the choice of a desirable shape and/or format is extremely limited, i.e. to exclusively flat batteries. Therefore, the shape of the housing of said electronic device is commonly adapted to the shape and format of batteries suitable for that specific device.

It is an object of the present invention to provide an improved electrochemical energy source which can be applied in an electronic device of any shape, i.e. without the described drawback and preserving the advantages of the prior art.

The object is achieved by an electrochemical source as described in the preamble and characterized in that the electrochemical energy source has a curved, planar geometry. A major advantage of the electrochemical energy source having a curved, planar geometry is that any desired shape of said electrochemical energy source can be realized, so that the freedom of choice as regards shape and size of said electrochemical energy source is many times greater than the freedom offered by the state of the art. The geometry of said electrochemical energy source can thus be adapted to spatial limitations imposed by any electrical apparatus in which the battery can be used, contrary to the techniques known of the prior art. Electrical apparatuses can now be more efficiently spatially configured in many cases because of the greater freedom of the choice of the geometry of the electrochemical energy source; this may lead to a saving of space in and greater freedom of design of the apparatus. It is to be noted that the curved planar geometry results in a curved battery which has a curved planar shape which may be concave/convex or wavy. However, it also imaginable for a person skilled in the art to apply an angular battery which has a hooked shape. The electrochemical energy source according to the invention may comprise rechargeable batteries, such as Li- or NiMH-batteries, non-rechargeable batteries, and supercapacitors. Said casing may comprise any non-conductive material, but is preferably manufactured of polymer, ceramic, composites, glass, metal provided with a non-conductive layer, or wood. The electrolyte may be formed by a solid state electrolyte. In this case the separator is commonly formed by the solid-state electrolyte. Preferably, a liquid-state electrolyte is used in the electrochemical energy source according to the invention. In this embodiment the separator is commonly soaked with said liquid-state electrolyte.

In a preferred embodiment, the electrochemical energy source comprises a lamination of said anode and said cathode, characterized in that the lamination has a curved shape such that the lamination is situated in one curved plane. Comparatively thin and elongated laminates can thus be provided in a relatively simple manner.

In another preferred embodiment, the electrochemical energy source comprises at least one assembly of electrochemical cells electrically coupled together, each cell comprising said anode, said first current collector, said cathode, said second current collector, said electrolyte, and said separator situated between said anode and said cathode, and insulation means for insulating one cell within said assembly from another cell within said assembly. Each assembly of electrochemical cells or each single electrochemical cell enclosed in a separate housing is also known as a battery. Each cell or each battery may be manufactured, for example, in advance and may be applied in the energy source when desired. The shape of each cell and each battery can be arbitrary. The overall assembly of cells (and batteries) determines the final shape of the electrochemical energy source. Preferably, more assemblies of cells and/or batteries electrically coupled together are applied. In a particular preferred embodiment, a pack of batteries is applied, said batteries being electrically coupled together, wherein each battery comprises at least one electrochemical cell. Said pack can thus have any desired shape determined by the orientation of batteries in said pack. In a preferred embodiment, at least part of said assemblies or pack is formed by conventional batteries. In this way conventional batteries can be use for forming the electrochemical energy source according to the invention. Said conventional batteries may also be formed by a specific configuration of one or more cells. In a particular alternative embodiment, said battery comprises a specific single electrochemical cell, also known as a “bicell”. These bicells or other batteries may manufactured, for example, by the known “Bellcore” technology, “gel” technology, or “Lithylene” technology. It must be noted that, if more batteries are applied, the batteries may be electrically coupled either serially or in parallel. The electrochemical cells within each assembly or battery may also be coupled electrically in a manner (serial or parallel) that depends on the needs of (said housing of) said electronic device. Thus, within the scope of the present invention different configurations of cells and batteries with different electrical connections may be used, which fit different electronic devices having different requirements.

The invention also relates to a method of the kind in accordance with the invention, characterized in that a suitable configuration for said electrochemical cell according to step B) is realized such that said electrochemical cell exhibits a curved, planar geometry. The advantages of a curved, planar geometry were described above. Said anode and cathode may be provided on the casing in various manners. A common manner of applying the active electrodes on the casing is by physical deposition techniques and by silkscreen printing and painting. It is also imaginable to apply conventional (porous) electrodes. The adapation of the configuration of said casing according to step D) may be realized, for example, by (ultrasonic) welding, diode “lasering”, mechanical deformation, thermal treatment, or polymerization of liquid-state polymers. As was mentioned above, it is imaginable to apply conventional (pre-assembled) batteries, such as the aforementioned bicells and batteries, to the casing according to step A). The application of said electrolyte according to step C) may be realized in a conventional manner. Optionally, the application of said electrolyte according to step C) is achieved by a vacuum treatment. If said electrolyte is a solid-state electrolyte, said solid-state electrolyte will usually also form a separator for separating said anode and said cathode. If a liquid-state electrolyte is used, an additional separator must be applied. The application of a (separate) separator may be incorporated in step A), but is preferably incorporated in step C). Said separator may either comprise a single separator as used, for example, in Li-ion and NiMH batteries, or comprise a separator adapted for lamination as used, for example, in Li-ion and NiMH based on the Bellcore technology, polymer gel technology, Lithylene semi-manufactures, and “UHMW” technology. If a separator adapted for lamination is used, mechanically stable batteries can be formed in situ by subjecting said formed batteries to a thermal treatment.

In a preferred embodiment, said electrochemical cell comprises an impermeable sheet surrounding said anode and said cathode. The impermeable sheet may either be applied in advance in the casing or it may be applied to said electrochemical cell before said cell is applied to said casing according to step A). In particular, the impermeable sheet is adapted to prevent leakage of a (liquid-state) electrolyte from said cell on the one hand and prevent intrusion of moisture and air from the local atmosphere into said cell on the other hand. Said impermeable sheet may be manufactured as an assembly of metal and/or polymer sheets. Optionally, the impermeable sheet is integrated with the casing of the electrochemical energy source during (injection) molding of said casing.

During the application of said electrochemical cell to said casing according to step A), multiple electrochemical cells are applied to said casing. The electrochemical cells are electrically coupled together thereby so as to form a battery. In this manner more batteries can be applied to said casing, each battery comprising more electrochemical cells. Said batteries are electrically coupled in series or in parallel. The coupling of cells is preferably realized in advance. As was noted above, said cells may comprise pre-assembled cells or may be made in situ.

In a last preferred embodiment, the electrochemical cell is subjected to a thermal treatment before said electrolyte and separator are applied to said casing according to step C). A stable electrochemical cell can be created in this manner. Possible techniques for forming a mechanically stable cell or battery of cells have been mentioned above.

The invention will be illustrated with the following non-restrictive examples.

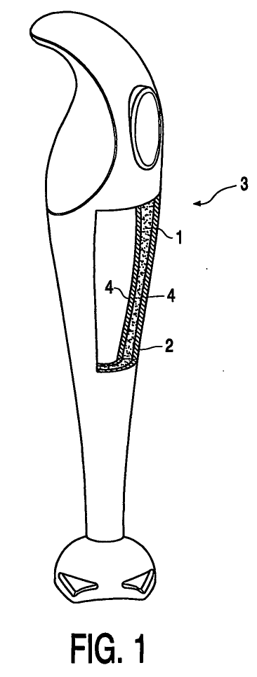

FIG. 1 shows a curved battery which is permanently positioned in and completely integrated with a housing of a domestic mixer; and

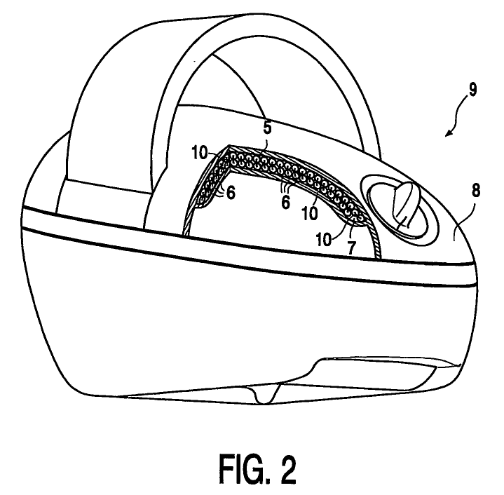

FIG. 2 shows a curved battery of pre-assembled electrochemical cells which is integrated in a chamber of a housing of a celest, an apparatus for removing cellulitis formed on body parts.

FIG. 1 shows a curved battery 1 which is permanently positioned in and completely integrated with a housing 2 of a domestic mixer 3. Said curved battery 1 is adapted to the need of the appliance, in particular said mixer 3, to accommodate an electrochemical energy source in an efficient and less voluminous manner. Said curved battery 1 may be of various types, but is preferably rechargeable in this application. Said curved battery 1 comprises an assembly of an anode, a cathode, an electrolyte, and separator means, which assembly is not shown in FIG. 1. Said assembly is hermetically packed in an impermeable sheet 4 to prevent leakage of liquid from said battery 1 on the one hand and to prevent intrusion of air, moisture, and other substances into said battery on the other hand. The method of manufacturing said battery 1 in said housing 2 as well as further advantages have been described in detail above.

FIG. 2 shows a curved battery 5 of pre-assembled electrochemical cells 6 which is integrated in a chamber 7 of a housing 8 of a celest 9, an apparatus for removing cellulitis formed on body parts. The cells 6 are all (electrically) serially coupled by means of conductive wires 10. Preferably, all cells 6 are rechargeable. The advantage of this embodiment is that a curved battery 5 can be formed with conventional and relatively cheap batteries, which, in general, can be adapted to the requirements of and internal space in a housing of an electronic device. Noted is that said curved battery 5 is fixed permanently in said chamber 7 of said housing 8. The provision of said curved battery 5 built into said housing 8 results commonly in a smaller overall size, lighter overall weight, and lower fabrication cost of said celest cleaner 9.

1. Electrochemical energy source integrally formed in a non-conductive casing, comprising:
a first current collector embedded in said casing and further coupled to an anode,
a second current collector embedded in said casing and coupled to a cathode, and
an electrolyte and a separator between said anode and said cathode,
wherein the casing comprises a portion of a housing of an electronic device,
characterized in that the electrochemical energy source has a curved, planar geometry.

2. Electrochemical energy source according to claim 1, characterized in that the electrochemical energy source comprises a lamination of said anode and said cathode, characterized in that the lamination has a curved shape such that the lamination is situated in one plane.

3. Electrochemical energy source according to claims 1, characterized in that said electrolyte is a liquid-state electrolyte.

4. Electrochemical energy source according to claim 1, characterized in that the electrochemical energy source comprises
at least one assembly of electrochemical cells electrically coupled together, each cell comprising said anode, said first current collector, said cathode, said second current collector, and said electrolyte and said separator situated between said anode and said cathode, and
insulation means for insulating one cell within said assembly from another cell within said assembly.

5. Electrochemical energy source according to claim 4, characterized in that at least one assembly is formed by a conventional battery.

6. Electrochemical energy source according to claim 4, characterized in that a pack of batteries is provided, said batteries being electrically coupled together, wherein each battery comprises at least one electrochemical cell.

7. Method of manufacturing an electrochemical energy source integrally formed in a non-conductive casing, wherein the casing comprises a portion of a housing of an electronic device, comprising the steps of:
A) applying at least one electrochemical cell to said casing, which electrochemical cell comprises an anode, and a cathode,
B) realizing a suitable configuration for said electrochemical cell,
C) applying an electrolyte to said casing, and
D) adapting the orientation of said casing such that said formed electrochemical energy source is at least substantially surrounded by said casing,
characterized in that the realization of a suitable configuration for said electrochemical cell according to step B) is achieved such that said electrochemical cell exhibits a curved, planar geometry.

8. Method according to claim 7, characterized in that said electrochemical cell comprises an impermeable sheet surrounding said anode and said cathode.

9. Method according to claim 7, characterized in that multiple electrochemical cells are applied to said casing during the application of said electrochemical cell to said casing according to step A).

10. Method according to claim 7, characterized in that the electrochemical cell is subjected to a thermal treatment before said electrolyte is applied to said casing according to step C).
